(19) United States
(12) Patent Application Publication
(10) Pub. No.: US 2020/0010182 A1
(43) Pub. Date: Jan. 9, 2020

(54) PIVOTING WING SYSTEM FOR VTOL AIRCRAFT

(71) Applicant: Joseph Raymond Renteria, Beaumont, CA (US)

(72) Inventor: Joseph Raymond Renteria, Beaumont, CA (US)

(21) Appl. No.: 15/773,406

(22) PCT Filed: Nov. 7, 2016
(86) PCT No.: PCT/US2016/060867

§ 371 Date: May 3, 2018

Related U.S. Application Data
(60) Provisional application No. 62/252,427, filed on Nov. 7, 2015.

(51) Int. Cl. B64C 27/28; B64C 29/00

(52) U.S. Cl. CPC B64C 27/28; B64C 3/385; B64C 29/0033

(57) ABSTRACT

A pivoting wing system, capable of vertical take-off and landing, having a hub connected to one or more wings provided on a spanwise axis. The wings are further provided with one or more thrust producing devices mounted to the top and bottom of the wings. The thrust producing devices are configured pivot the wings about the spanwise axis. The wings generate lift for forward flight situations, and the configuration allows for controlled vertical and horizontal flight. The wings may also be configured as rotary elements and enable the system to take flight like a helicopter.

### CROSS-REFERENCE TO RELATED APPLICATION(S)

The present application claims priority to U.S. Provisional Patent Application No. 62/252,427 filed on Nov. 7, 2015, entitled “Pivoting wing, thruster and hub system for VTOL aircraft” the entire disclosure of which is incorporated by reference herein.

### BACKGROUND OF THE INVENTION

### Field of Invention

The present invention relates generally to a pivoting wing, thruster and hub system for aircraft. Furthermore, the pivoting wing system allows the aircraft to perform vertical and horizontal flight.

### Description of Related Art

In the world of aviation there are many different types of aircraft that are each designed with specific traits. Planes offer a longer range of flight as well as greater flight speeds, while helicopters allow for vertical take-off and landing (VTOL) as well as provide hovering capabilities. As such, it has become desirable to combine the benefits of both airplanes and helicopters into one aircraft. Thus, aircraft capable of vertical take-off and landing have become an increasingly popular aircraft design as they offer the versatility of being used in several different types of aircraft missions. However, there are flaws in the design of many of these types of aircraft.

Many VTOL aircraft feature tilting rotors and complex rotor heads or separate lift and thrust systems. This results in an expensive, heavy and most of all complex design which increases difficulty in maintenance and operation while decreasing dependability. The efficiency of such designs also suffers greatly, usually to the point that the design offers little advantage over a conventional helicopter.

The conventional rotary wing concept comes with plenty of its own downfalls. Helicopters are slow and inefficient when compared to fixed wing aircraft. They also require complex mechanisms in order to keep the aircraft under control, which adds greatly to their cost and maintenance.

Therefore it is the object of the present invention to provide a pivoting wing, thruster and hub system for VTOL aircraft that is capable of efficient and controlled vertical and/or horizontal flight, while being extremely simple, lightweight and inexpensive in design.

### SUMMARY OF THE INVENTION

The present invention is a pivoting wing system, capable of vertical take-off and landing. In an embodiment, the present invention comprises of a hub having a first and second end. Wherein a wing is provided at the first end of a hub having one or more thrust producing devices mounted on the top of the wing, and one or more thrust producing devices mounted on the bottom of the wing. In an embodiment, the configuration allows the thrust producing devices to rotate about a spanwise axis, as defined by the wing-span.

In another embodiment, the pivoting wing system comprises a hub having a first and second end, wherein a wing assembly is provided on the first and second ends of the hub. Each wing assembly is further provided with one or more thrust producing devices mounted on the top of the wing, and one or more thrust producing devices mounted on the bottom of the wing. The arrangement allows the thrust producing devices to rotate the wings about the spanwise axis, as defined by the wing-span.

In an embodiment, a fuselage is mounted underneath the hub. The fuselage may further contain a landing component and stabilizing components, which may be additional thrust producing devices.

In an embodiment, the pivoting wing system will be provided one or more positioning sensors to maintain correct rotation of the wings about the spanwise axis. Furthermore, sensing devices or IMUs may be utilized to appropriately determine the rotational speed of the thrust producing devices to properly maneuver the pivoting wing system.

In an embodiment, the pivoting wing system will be provided with a power source to provide power to the thrust producing devices, sensors, and other systems of the pivoting wing. The power source may be a battery or other energy producing or storing system.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the pivotable wing, according to an embodiment of the present invention;

FIG. 2 is a perspective view of the pivotally connected wing in a pivoting position, according to an embodiment of the present invention;

FIG. 3 is a perspective view of the pivotally connected wing in a partial pivoting position, according to an embodiment of the present invention;

FIG. 4 is a perspective view of the pivotally connected wings in a vertical position, according to an embodiment of the present invention;

FIG. 5 is a front view of pivotally-connected wing, according to an embodiment of the present invention;

FIG. 6 is a perspective view of an alternative embodiment of pivotally-connected wing, according to an embodiment of the present invention;

FIG. 7 is a perspective view of the pivotally-connected wing wherein payload components are axially connected to the hub, according to an embodiment of the present invention;

FIG. 8 is a perspective view of the pivotally-connected wing, wherein the yaw behavior of payload components is controlled by thrust producing devices and/or stabilizing surfaces, according to an embodiment of the present invention;

FIG. 9 is a perspective view of a further embodiment of the pivotally-connected wing, wherein the hub is a pivotal connection point for two opposing wings, according to an embodiment of the present invention;

FIG. 10 is a perspective view of a further embodiment of the pivotally-connected wing wherein a landing gear wheel also enabling travel across a surface, according to an embodiment of the present invention;

FIG. 11 is a perspective view of the wing wherein the wings are in a vertical position, according to an embodiment of the invention;

FIG. 12 is a perspective view of the wing in rotary wing flight mode, according to an embodiment of the invention;

FIG. 13 is a detail view of the wing in a preferred thruster configuration, according to an embodiment of the invention;

FIG. 14 is a detail view of the wing having redundant thrusters, according to an embodiment of the invention;

FIG. 15 is a detail view of the wing having staggered thruster assemblies, according to an embodiment of the invention;

FIG. 16 is a detail view of the wing having multiple thrusters, according to an embodiment of the invention;

FIG. 17 is a detail view of the wing as a single wing with a counterweight, according to an embodiment of the invention;

FIG. 18 is a detail view of the wing as a single wing with a thruster counterweight, according to an embodiment of the invention;

FIG. 19 is a detail view of the wing in rotary wing mode, according to an embodiment of the invention;

FIG. 20 is a perspective view of a further embodiment of the pivotally-connected wing wherein a landing gear wheel also enabling travel across a surface, according to an embodiment of the present invention;

FIG. 21 is a perspective view of an embodiment of the pivotally-connected wing with a fuselage beside the wing;

FIG. 22 is a perspective view of an embodiment of the pivotally-connected wing having a single rotor wing;

FIG. 23a-f depicts an embodiment where the aircraft goes from rotary to fixed wing flight by losing altitude then recovering;

FIG. 24a-c depicts an embodiment where the aircraft goes from fixed to rotary wing flight by inducing a stall, then flipping one wing over;

FIG. 25a-e depicts an embodiment where the aircraft goes from rotary to fixed wing flight by pitching the wings downward until they are aligned, and then pitching them up together;

FIG. 26a-e depicts an embodiment where the aircraft goes from fixed to rotary wing flight by pitching the wings downward until they are pointed downward, and then pitching them in opposite directions; and

FIG. 27 is a perspective view of the pivoting wing system comprising 3 wings for rotary flight, according to an embodiment of the present invention.

### DETAILED DESCRIPTION OF PREFERRED EMBODIMENTS

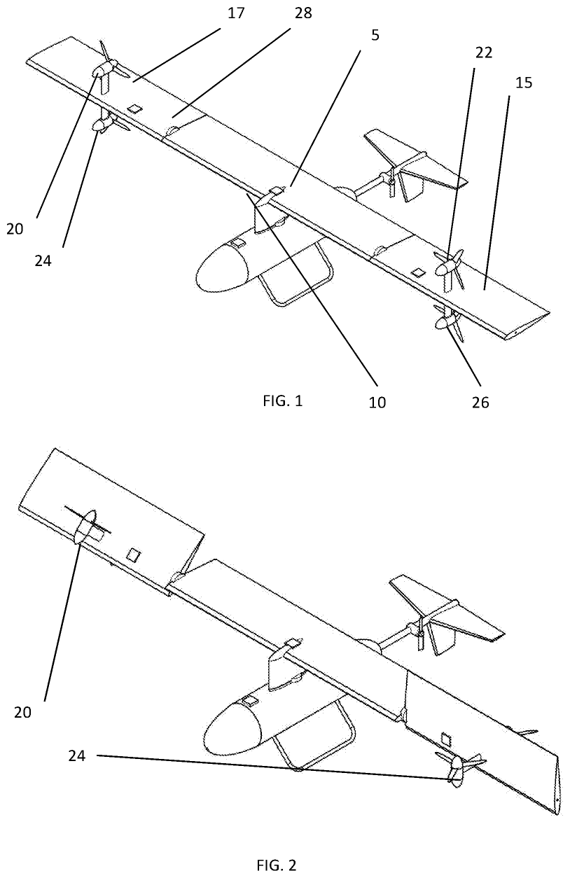

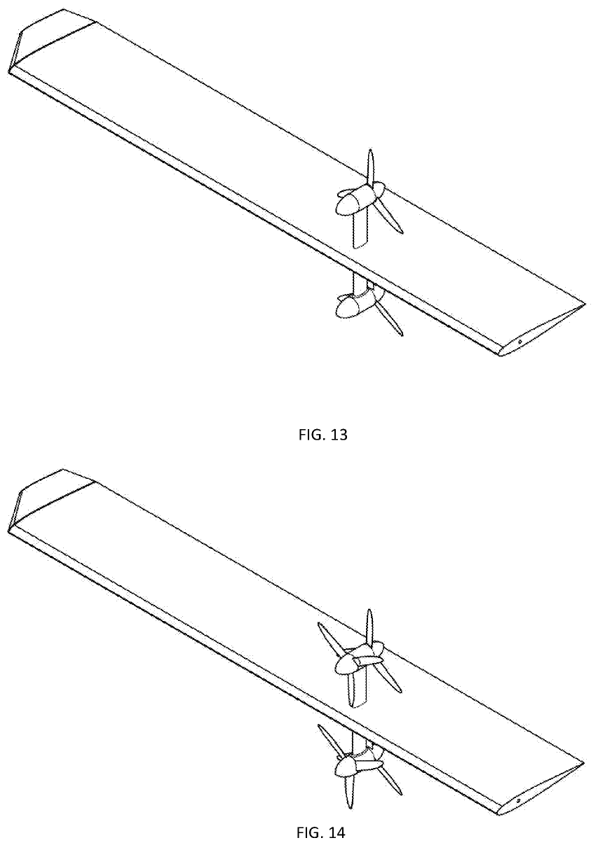

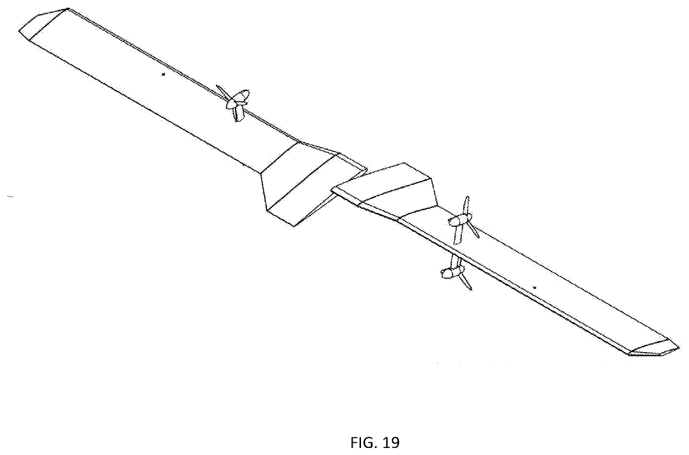

Preferred embodiments of the present invention and their advantages may be understood by referring to FIGS. 1-32, wherein like reference numerals refer to like elements. All illustrations of the drawings are for the purpose of describing selected versions of the present invention and are not intended to limit the scope of the present invention.

The present invention comprises a pivoting wing, thruster and hub system for an aircraft, allowing an aircraft to perform vertical and/or horizontal flight with varying attack angles of the wings, to vary the lift and flight characteristics of the aircraft. In reference to FIG. 1, the system is comprised of a hub 5 which is able to freely rotate around a vertical axis, either by rotating around its own mass, or by being axially connected to another structure in order to provide lift as in a helicopter.

The hub is optionally mounted to a fuselage 10 or other vehicular structure. The said vertical axis will be referred to as the hub axis. In reference to FIGS. 1 and 2, one or more wings 15, 17 are pivotally connected at one end to the hub 5, and are able to freely pivot around a generally horizontal wing pivot axis which allows them to change their pitch. In an embodiment, wing pitch control is provided solely through differential thrust forces on the top and bottom of the wings. The wings may be electronically and/or mechanically limited in range of motion, which eliminates the need for slip rings to provide power to the thrusters, and it is not necessary for the wings to perform complete or continuous revolutions. In another embodiment, the battery may preferably turn with the hub, eliminating the need for slip rings, and acting as a balancing counterweight for the hub. For example, in the preferred embodiment (FIG. 1) there is a wing shaped hub which is mounted off center to coincide with the center of lift. The external vertical section of the hub may house the battery, countering the weight of the wing. Additionally, the battery may be contained within the fuselage/airframe, but still connected to and spinning with an external hub.

The pitch position of the wings as well as the position of the wings around the vertical axis may be determined by rotary position sensors, internal measurement units (IMUs), and compasses (not shown). In an embodiment, stepper motors may be used as axles, allowing them to act as rotary position sensors as well as assist in positioning hubs and pivoting wing sections.

In some embodiments, there may not be a physical hub, just a vertical axis. In some embodiments, the hub may rotate in relation to the airframe, or the airframe may rotate with the hub with the help of spinning landing gear or a pivot point. In other embodiments the pivotal connection may simply be a flexible wing structure.

In a preferred embodiment, the system has two wings 15, 17 pivotally connected to the hub 5, wherein each wing protrudes from a side of the hub 5. One or more upper thrusters 20, 22 and/or lower thrusters 24, 26 may be mounted on each of the wings 15, 17, to provide forward thrust. Each of the thrusters 20, 22, 24 and 26 may be contained within an assembly 28 which contains the thruster and other mechanisms such as thrust control. At least one upper thruster assembly 28 and/or at least one lower thruster assembly 28, each containing at least one thruster, is connected to each wing 15, 17.

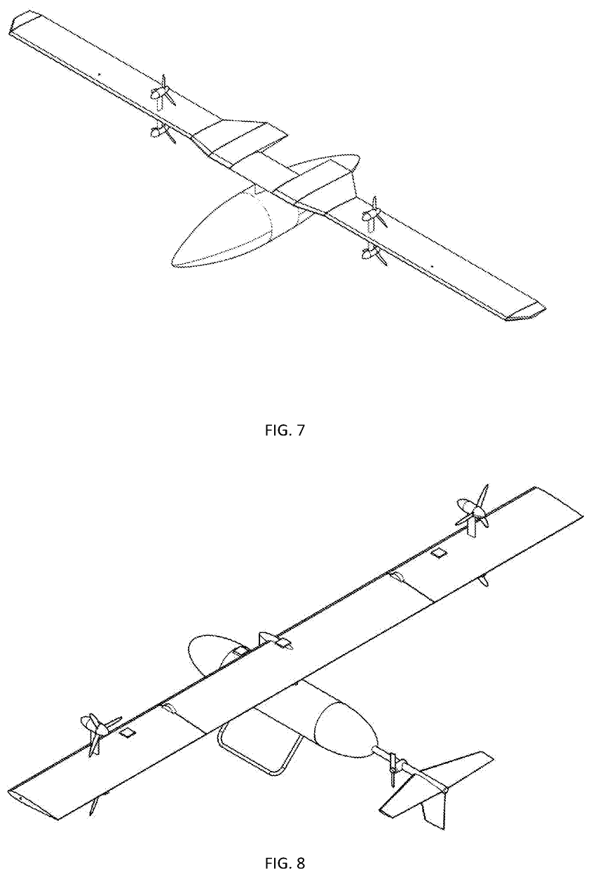

In reference to FIGS. 5 and 13-16, the at least one upper thruster 20, 22 is located above the wing pivot axis of the one or more wings, and the at least one lower thruster 24. 26 is located below the wing pivot axis of the one or more wings. The at least one upper and at least one lower thruster assemblies are oriented perpendicular to the longitudinal span of the wing in such a way that they may collectively drive the connected wing substantially forward or rearward. In one embodiment, the pitch of the wing 15, 17 is simultaneously controlled by the rotation on the wing 15, 17 relative to the hub 5 through differential thrust between the at least one upper and at least one lower thruster assemblies. In another embodiment, an actuator within the hub or wings rotates the wings 15, 17 relative to the hub. 27. In one embodiment, there are no actuators within the wing or hub. The thrusters drive the wing around a vertical axis while simultaneously controlling the pitch of the wings. There may be mechanical stops to limit complete rotation. The wings may be pivotally connected by bearings or bushings and may rotate on blade grip like structures or may rotate around a wing spar. A pivotal connection may also be achieved through a flexible wing structure, where the wing is used for rotary wing flight only and does not need to flip around. Where only one wing is used, a counterbalance device may be placed around the hub axis, opposite of the said one wing to counter the mass of the said one wing as it rotates around the hub axis. Where one wing and a counterbalance device is used, the counterbalance device may be connected directly to the hub, or it may be connected directly to, and pivot with the said one wing. Where the said counterbalance is used, the said at least one upper and at least one lower thruster assemblies may be connected directly to the said counterbalance as opposed to being connected to the said one wing.

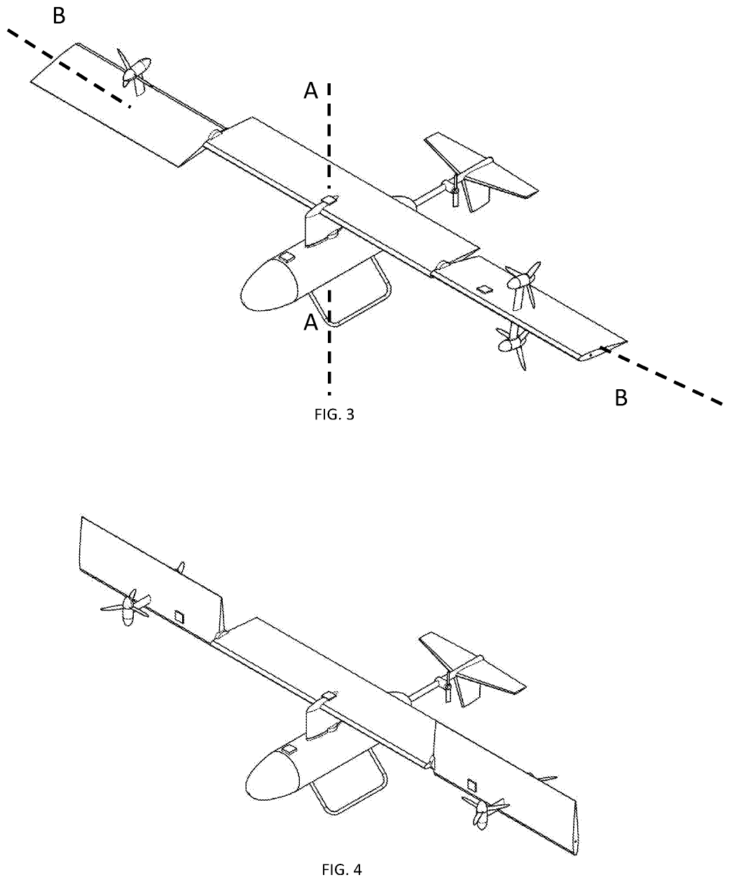

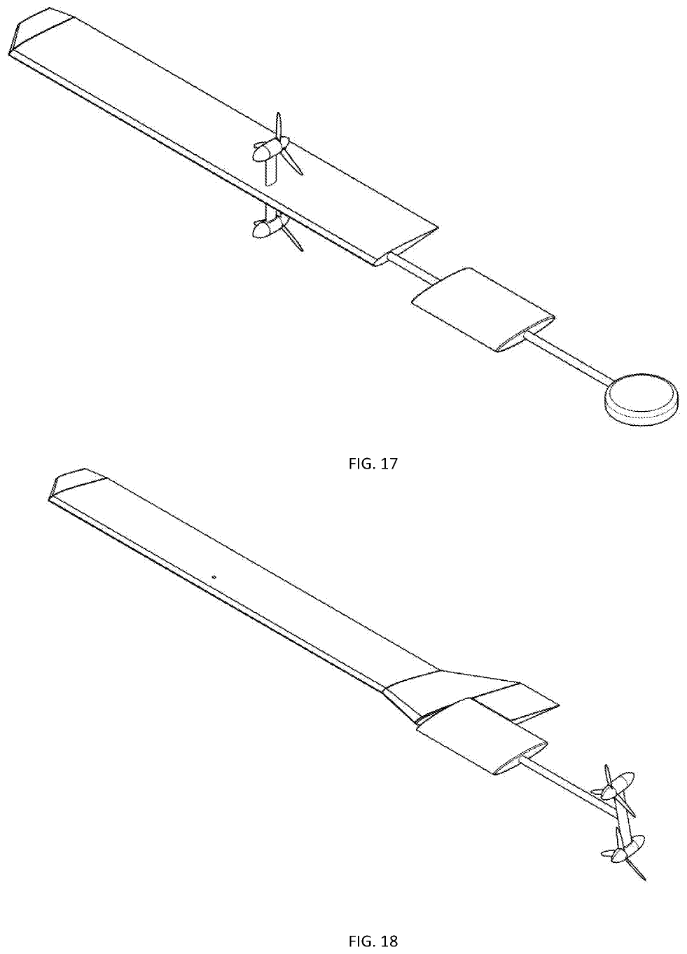

In reference to FIGS. 3, 12, and 19, in a preferred embodiment, two opposing wings reorient themselves to form a helicopter rotor and are driven around the hub axis by the thrusters resulting in vertical flight. Alternately, with reference to FIG. 1, the two wings may be driven together in the same direction along a horizontal axis resulting in fixed wing flight, with an adjustable anhedral or dihedral for the wing. In reference to FIGS. 5 and 13-16, each wing utilizes at least two thruster assemblies. Each thruster assembly may contain one or more nacelles, housing at least one thruster as well as some form of bracket or other means of mounting the thruster to the at least one wing and/or counterbalance. In reference to FIG. 5, where the said two or more thruster assemblies are located directly above and below one another, they may be connected and essentially embody one thruster assembly which is capable of generating an array of thrust vectors which are distributed vertically across the wing pivot axis of the said one or more wings. The present invention enables an aircraft to perform vertical flight. With reference to FIGS. 17 and 18, during vertical flight the said one or more wings rotate around the hub axis, creating lift as they are driven around the hub by their connected upper and lower thruster assemblies, where the upper and lower thruster assemblies also control the pitch of the one or more wings enabling collective and cyclic pitch control over the wings as they rotate around the hub axis. The present invention also enables an aircraft to perform horizontal flight, where the said one or more wings are specifically two opposite wings, where one wing may serve as a right wing and the other wing may serve as a left wing. During horizontal flight the two opposite wings do not rotate around the hub, however the opposite wings create lift as they travel together along a horizontal axis as they are driven forward by their connected upper and lower thruster assemblies, where the upper and lower thruster assemblies also control the roll, yaw and pitch control over the wings and therefore any connected aircraft. The pivoting wing, thruster and hub system is also capable of performing conventional takeoffs and landings. The pivoting wing, thruster and hub system may convert between vertical and horizontal flight modes before or during flight. The pivoting wing, thruster and hub system may be applied to an existing aircraft fuselage, wherein the hub does not rotate or the wings may have axial connections to the fuselage. In an embodiment, the wings connected to the fuselage may simply flex about the spanwise axis.

With reference to FIG. 3, the hub 5 provides a point of connection for the said one or more wings, which is able to rotate around a vertical axis, either by rotating around its own mass, or by being axially connected to another structure such as the fuselage 10, where the said one or more wings 15, 17 may be pivotally connected at the inner end, enabling the said one or more wings to collectively rotate around the hub axis A while allowing them to individually pivot around the wing pivot axis B. The hub may be designed to generate lift, having an airfoil shaped cross section and being circular, or the hub may be elongated in shape similar to a conventional wing (FIG. 3). If the design of the hub 5 is intended to create lift, the size of the hub may be exaggerated in size. Alternatively, any axle the hub rotates around may be designed to generate lift and be exaggerated in size, or altered in cross-section accordingly. Finally, lift-generating devices such as wings or disks wings can be mounted directly to the axle or hub.

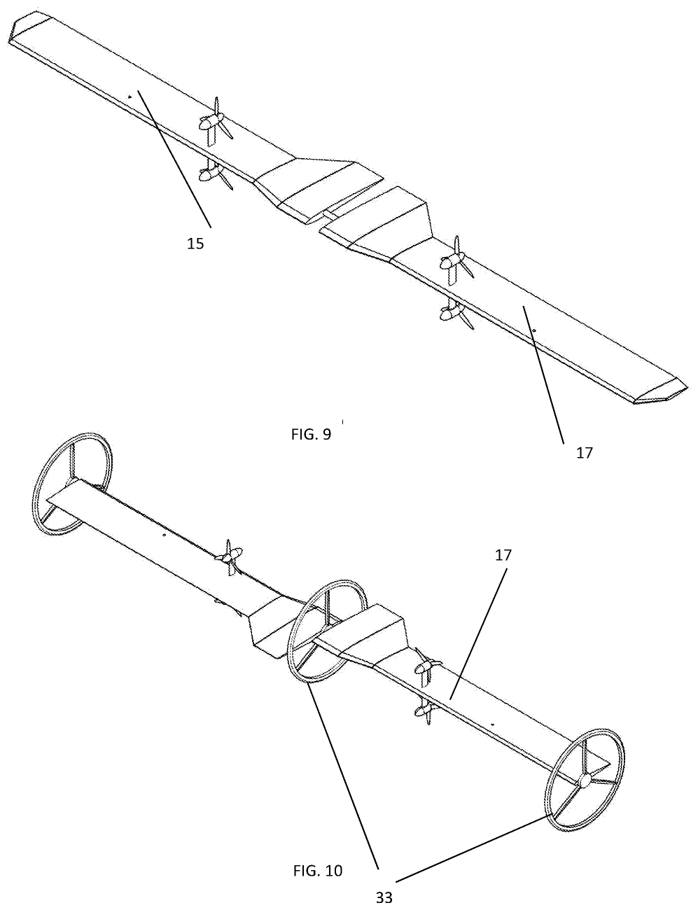

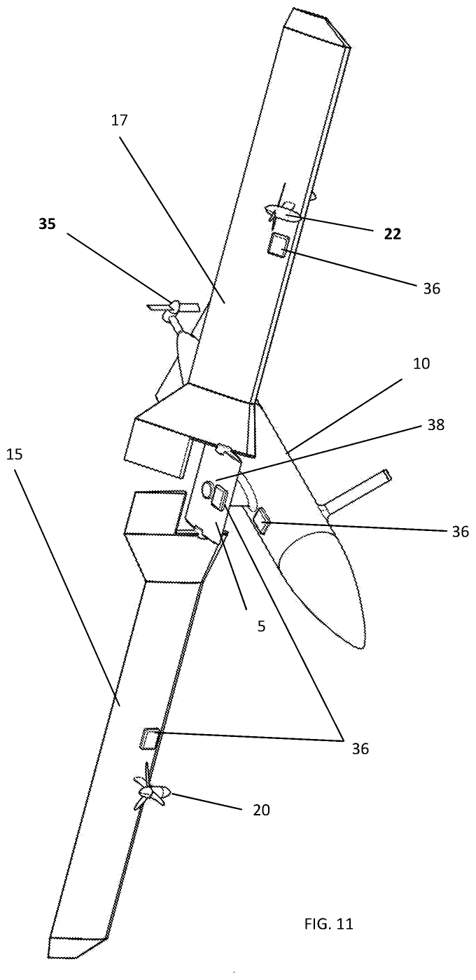

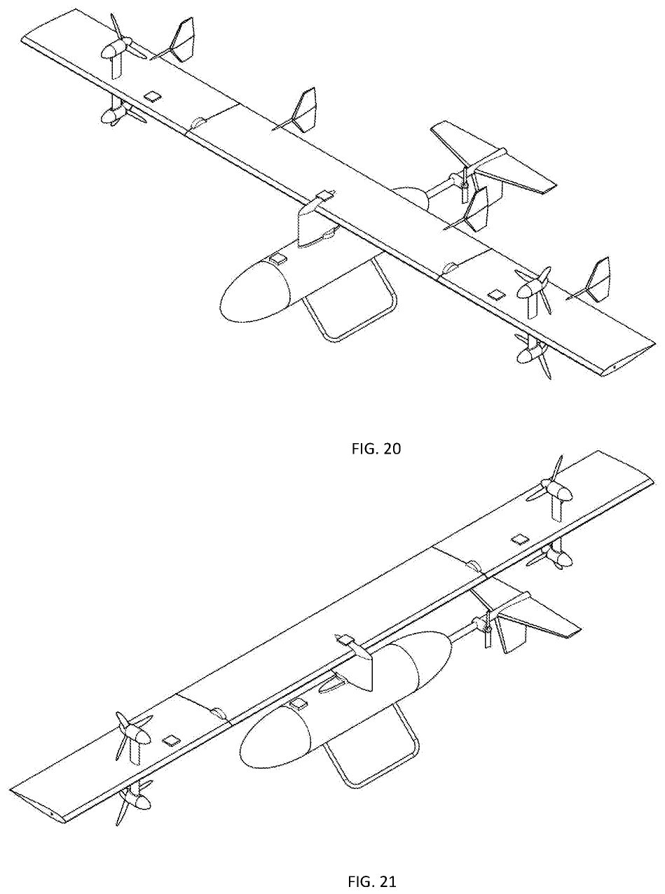

In some embodiments, various combinations of payload components such as a fuselage or similar payload structure, landing gear, reconnaissance payloads and weapons payloads may serve as the hub of the pivoting wing, thruster and hub system, and so are pivotally attached to the said one or more wings. In reference to FIG. 1, in such embodiments these components will rotate around the hub axis along with the wings during vertical flight. In embodiments where payload components rotate around the hub axis along with the wings, cameras, lights, weapons systems or other devices may need to be coordinated with the rotation of the aircraft. For example, if the aircraft rotates once per second, and it is recording video at one frame per second, it is possible to gather surveillance video which appears to be recorded from a stationary platform. In reference to FIG. 9, in one very simple embodiment, the hub may simply be a shaft or similar structure where two wings are connected at the root. In reference to FIGS. 10 and 20, landing gear may be as simple as one or more wheels 33, or rounded structures, which may or may not be able to rotate around the shaft like-hub. Wheels could also be attached anywhere along the span of the wings 15, 17 including the wingtips to facilitate takeoffs and landings, as well as traveling along a surface. Any number of methods can be used to provide a pivot point which is in contact with the ground, allowing the hub 5 to rotate around its vertical axis A. Any such pivot point A may be rigidly connected to the structure serving as the hub, or axially connected so that it may stay stationary as the hub structure rotates.

In some embodiments, payload components such as a fuselage 10 or similar payload structure, landing gear 33, reconnaissance payloads and weapons payloads, may be axially connected to the hub of the pivoting wing, thruster and hub system, hanging below or sitting above the hub as it rotates around the hub axis. In reference to FIG. 7, such payload components may be left to freely rotate around the hub axis, allowing factors such as friction from the axial connection to the hub, direction of travel and crosswinds to affect the yaw behavior of such components. In reference to FIG. 8, one or more empennages, control surfaces and thrust generating devices may be connected to such payload components, or connected to booms which are connected to such payload components in order to control the yaw behavior of such components. Alternatively, the axial connection between the hub and any payload components may be motorized, allowing active control over the yaw behavior of any axially connected payload components. In another embodiment, the payload or fuselage component may be absent (FIG. 6.)

In reference to FIG. 8, the pivoting wing 15, 17, thruster 20, 22, 24, 26 and hub 5 system may be axially mounted to a horizontally arranged airframe, such as a conventional helicopter or a fixed wing aircraft. In other embodiments, the pivoting wing and thruster system may be axially or rigidly mounted around the fuselage of a vertically arranged airframe such as a tail sitter aircraft similar to a Triebflügel.

The function of the said one or more wings 15, 17 is to generate lift during both vertical and horizontal flight, and they may be any size or shape to achieve that end. The at least one wing 15, 17 may have an amount of dihedral or anhedral. Alternatively, the root of the wing 15, 17 may be connected to the hub 5 at an angle, creating dihedral or anhedral for the wing, and generating lift or downforce, respectively. Wings may be swept or un-swept with a high or low aspect ratio. A variety of airfoils including symmetrical, asymmetrical, elliptical and bidirectional airfoils may be used. For efficiency, outer airfoil sections which provide most of the lift during rotary wing flight may be symmetrical while inner airfoil sections which produce most of the lift during fixed wing flight may be cambered. In the preferred embodiment the hub has a cambered airfoil section. Of course any airfoil can be used anywhere. Wings may be detachable, fold-able or telescoping for ease of transport. Where wings are made to be fold-able or telescoping, they may be designed to deploy under centrifugal force once they are rotating around the hub. Sections of the wing may remain stationary, while others are designed to pivot. While at least one pivoting wing must be attached to the hub, and at least two thruster assemblies attached to each pivoting wing, there may be additional non-pivoting wings attached to the hub. Furthermore, none-pivoting wings may have a variety of thruster configurations connected to them. The said one or more wings may have connected empennages to aid in stability during vertical and/or horizontal flight. Alternatively, wings may be designed to naturally pitch into any relative wind, through airfoil design and/or pivot axis placement. Any hubs, pivoting wing sections and fuselages may be actively or passively stabilized with empennages, as depicted in FIG. 20.

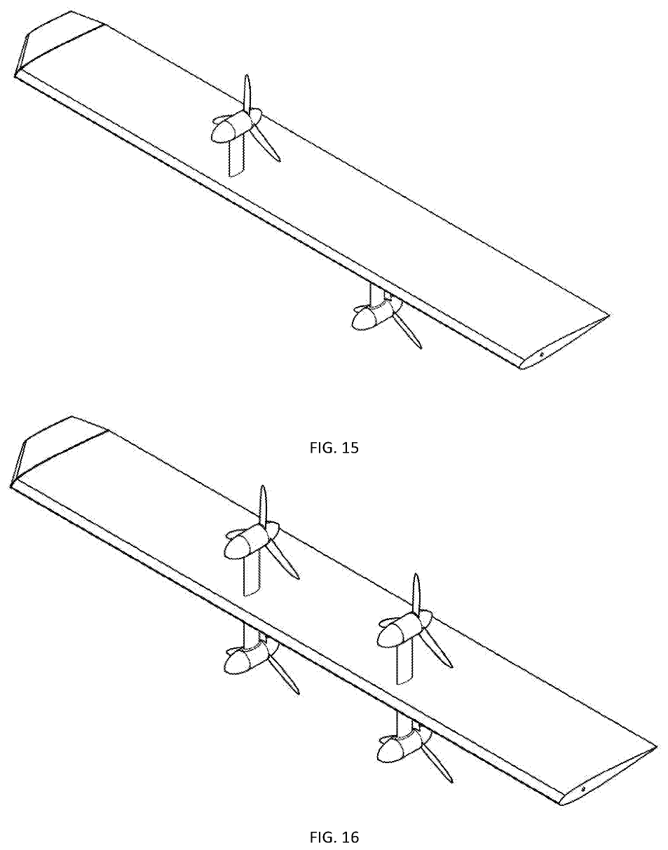

With reference to FIGS. 11 and 13-16, the function of the thruster assemblies is to provide a force urging each wing forward to generate lift as air passes around the wing, as well as controlling the pitch of the wings and being able to slow the wings by reversing their produced thrust or by reorienting the wing resulting in the wing being propelled in the reverse direction. With reference to FIGS. 6 and 13-16, the at least two thruster assemblies may use any thrust generating devices in order to generate a thrust vector sufficient to drive the said one or more wings substantially forward and/or rearward. The at least two thruster assemblies may create thrust vectors which are parallel or nonparallel in relation to each other. Viewing FIG. 15, thruster assemblies may be staggered anywhere along the span or chord of the wing 15, 17. With regard to FIG. 16, multiple and redundant thrusters or thruster assemblies may be used to increase safety and dependability of operation. Where motors with propellers or rotors are used to generate thrust, multiple motor elements may be used in conjunction with a shared or connected shaft/shafts to improve safety and dependability of operation. With reference to FIG. 5, stabilizers may be present on the thrusters to orient the thrusters parallel with the direction of travel.

The hub 5, and any connected fuselages 10 or payload components, whether they be rigidly or axially connected, may be passively or actively oriented throughout vertical and horizontal flight envelopes. Such components may simple hang in place during flight due to gravity, and/or they may be positioned by the effects of centripetal force during vertical flight and/or they may be positioned by control surfaces/stabilizers in relation to relative wind.

More than one pivoting wing, thruster and hub system may be used on the same aircraft, including longitudinally and laterally arranged tandem configurations, as well as coaxial and contra-rotating configurations. Additionally, the multiple pivoting wing and thruster systems may each use one or more wings. Where more than one pivoting wing, thruster and hub system are used, two or more of them may be mechanically or electronically timed to function together in a coordinated manner to improve performance by synchronizing various states of mass distribution and aerodynamics.

In one embodiment, coaxial pivoting wing, thruster and hub systems are axially connected to an airframe and/or other payload components, resulting in and aircraft which resembles a biplane during horizontal flight, and a coaxial helicopter during vertical flight.

In another embodiment, the hub 5 and/or the axial connection means of the hub, of a pivoting wing, thruster and hub system functions as a rotating and/or stationary disk wing aircraft, providing lift during horizontal flight and during transition to horizontal flight.

Various electronics and sensors such as inertial measurement unit sensors, rotary position sensors for determining the wing angle relative to the hub, computers and other devices may be used to calculate the position and speed of various components of a pivoting wing, thruster and hub system as well as any axially connected payload components. Such sensors may be placed within the hub, within he wings and within any axially connected payload components. Sensors, and specifically IMU sensors, rotary position sensors, magnetic/compass sensors and GPS receivers may be used to determine the position and/or speed of the wings, hub and any axially connected payload components in relation to each other and in relation to space. Feedback information collected by these various sensors may be collected and processed by on board or off board processors which may then give response commands to the thruster assemblies, which ultimately control the position and generated thrust for each wing, which in turn control the pivoting wing, thruster and hub system. The yaw behavior of any axially connected payload components which are attached to the hub of the pivoting wing, thruster and hub system may simultaneous be regulated in response to sensor feedback and based on desired flight commands. Alternatively, the yaw behavior of any axially connected payload components may be controlled by a separate sensor feedback and output system, and act completely independently of the pivoting wing, thruster and hub system. Additionally, the yaw behavior of any axially connected payload components may be completely passive, relying upon relative wind, direction of travel or nothing at all for orientation.

Any combination of IMUs and/or rotary position sensors, or complete lack of them could be used. The figures depict both IMUs and rotary position sensors to determine the position of the wings, hub and fuselage in relation to each other and/or the horizon. Positioning sensors monitoring wing pitch could be eliminated where thruster motor rpm is monitored instead or wing pitch. With reference to FIG. 11, the rectangular components 36 on the fuselage, hub and wings are IMUs which could contain gyros, accelerometers and compasses. The round components 38 on the hub and between the hub and the wings are rotary position sensors.

The pivoting wing and thruster system is designed to provide thrust and lift as well as pitch, roll and yaw control for a large variety of aircraft and configurations. However, conventional control surfaces, additional thrusters and additional wings may be used as needed, and may be especially useful while transitioning between vertical and horizontal flight modes. Additional thrust producing means may also be used to provide additional lift during transitional periods.

The preferred embodiment utilizes two opposing wings, as they can serve as a right wing and a left wing during horizontal flight. Transitioning from vertical flight to horizontal flight and back again can be accomplished before or after takeoff by repositioning the two opposing wings by pivoting them around their wing pivot axis. The pitching movement of the one or more wings is controlled through differential thrust between the at least one upper and at least one lower thruster assembly.

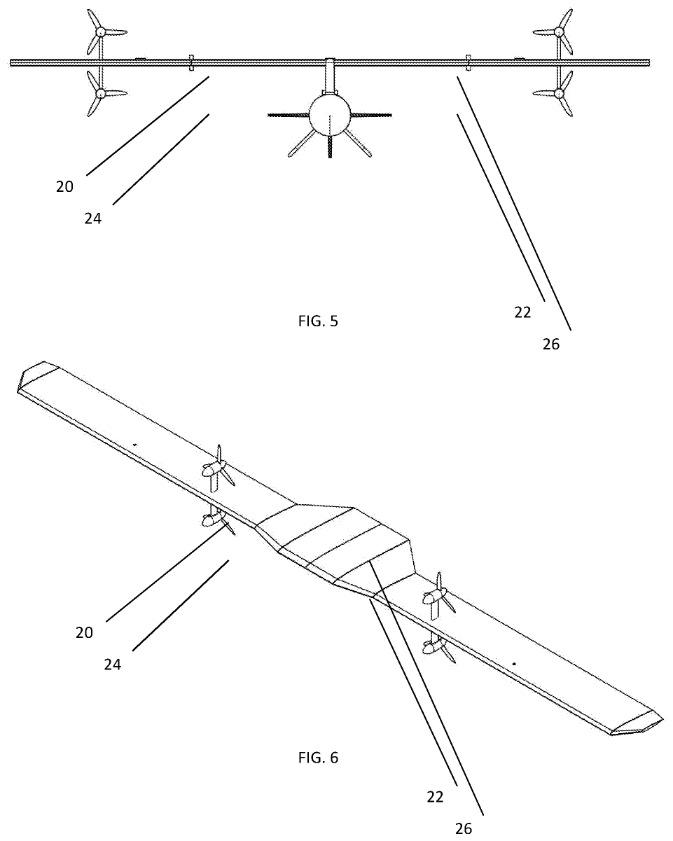

Transitioning between vertical and horizontal flight can be accomplished by any number of methods. One method for transitioning between flight modes using the preferred, two opposing wing embodiment is to progressively pitch the wings downward during vertical or horizontal flight, until they are both pointing straight down, resulting in the aircraft entering a state of descent. In reference to FIG. 4, at this point the aircraft is essentially flying straight down. The wings can then be progressively pitched upward until the aircraft is able to enter a state of horizontal flight.

Another transition method using the preferred two-wing embodiment does not require the aircraft to enter a state of descent, or limits the amount of descent required to transition. For example, with reference to FIG. 4 the aircraft may be in a state of vertical flight, but preferably flying forward fast enough for lift generating surfaces to have some effect. At this point, one or more pivoting wing, thruster and hub systems integrated into the aircraft can slow down and stop rotating around the hub. In this embodiment, the fuselage terminates in a stabilizer that passively or actively controls the rotation of the fuselage. If necessary, the one or more wings can reorient themselves for horizontal flight, and then enter into a state of horizontal flight. One or more pivoting wing, thruster and hub systems can make this conversion simultaneously, or in a sequence. To revert back to a state of vertical flight, one or both wings can then reorient themselves if needed, and begin rotating around the hub and the said vertical axis. Additional, conventional wings and lift generating surfaces may be attached to, or deployed from the airframe to provide sufficient lift during the transition process. Any stabilizing surfaces or empennages may be actively or passively retracted or deployed during transitional, vertical and horizontal states of flight.

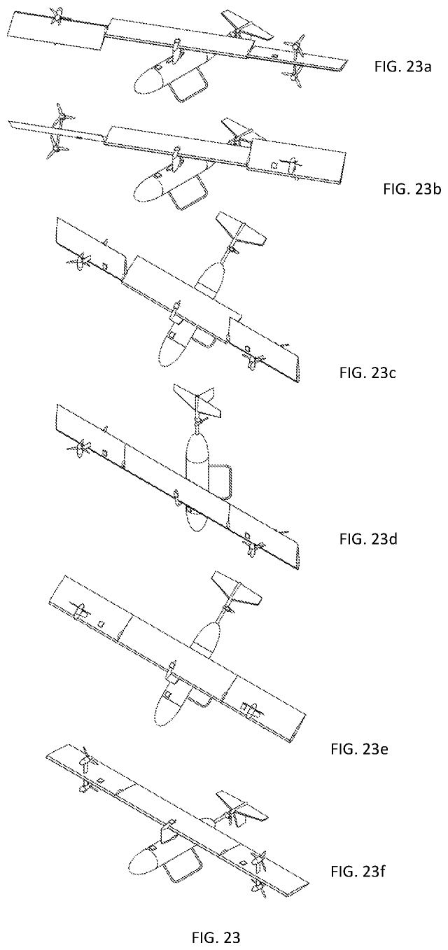

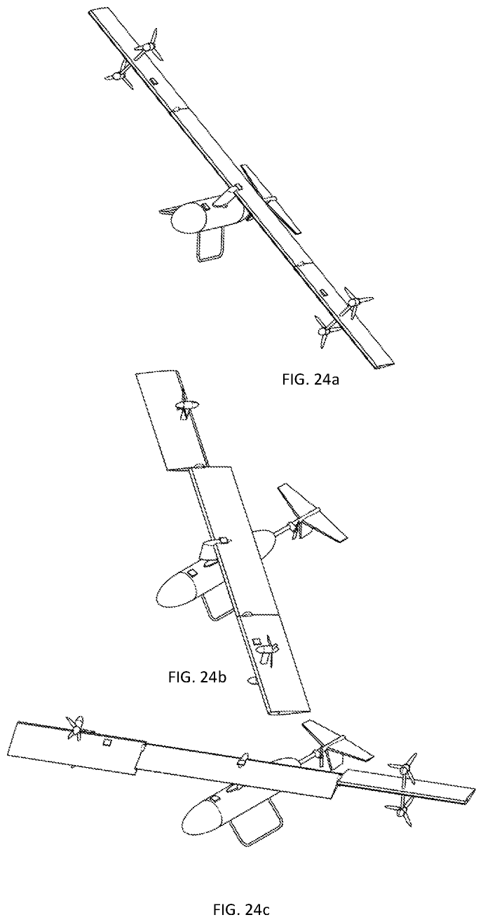

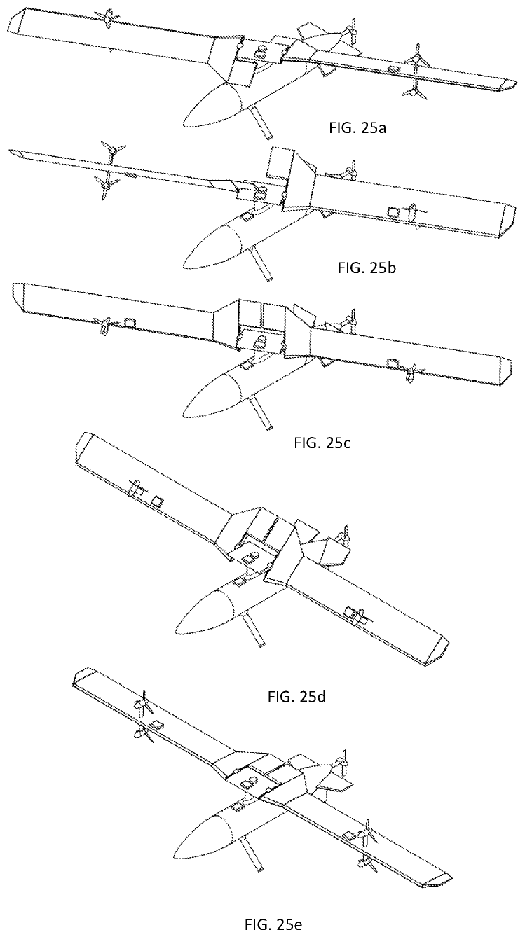

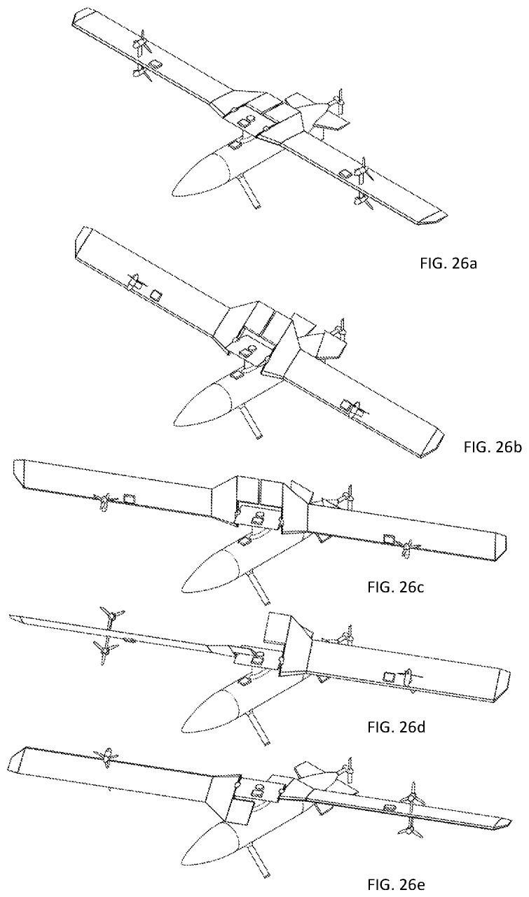

With reference to FIGS. 23 26 various transitioning methods are shown. FIG. 23a-f depicts an embodiment where the aircraft goes from rotary to fixed wing flight by losing altitude then recovering. FIG. 24a-c depicts an embodiment where the aircraft goes from fixed to rotary wing flight by inducing a stall, then flipping one wing over. FIG. 25a-e depicts an embodiment where the aircraft goes from rotary to fixed wing flight by pitching the wings downward until they are aligned, and then pitching them up together. FIG. 26a-e depicts an embodiment where the aircraft goes from fixed to rotary wing flight by pitching the wings downward until they are pointed downward, and then pitching them in opposite directions.

With reference to FIG. 23a-f, in 23a. the aircraft is depicted at the top in rotary flight mode, in 23b, aircraft begins to lose altitude as wings pitch downward, in 23c, outer airfoils and fuselage begin to pitch downward into relative wind. In 23d, aircraft is in a dive, in 23e. the aircraft pulls out of a dive, and in 23f the aircraft enters fixed wing flight.

With reference to FIG. 24a-c, in 24a. aircraft in fixed wing flight induces a stall, in 24b, one wing flips over, and in 24c the aircraft enters rotary wing flight. With reference to FIG. 25a-e, in 31a the aircraft is in rotary wing flight, in 25b the wings begin to pitch downward as aircraft loses altitude. In 25c, both wings align themselves by pitching substantially downward. In 25d the wings begin to pitch upward in the same direction, and in 25e the aircraft enters fixed wing

With reference to FIG. 26a-e, in 32a the aircraft is in fixed wing flight, in 32b the wings begin to pitch downward as aircraft loses altitude, in 26c both wings point substantially downwards. In FIG. 26d, the wings begin to pitch upward in opposing directions, and in 26e the aircraft enters rotary winged flight.

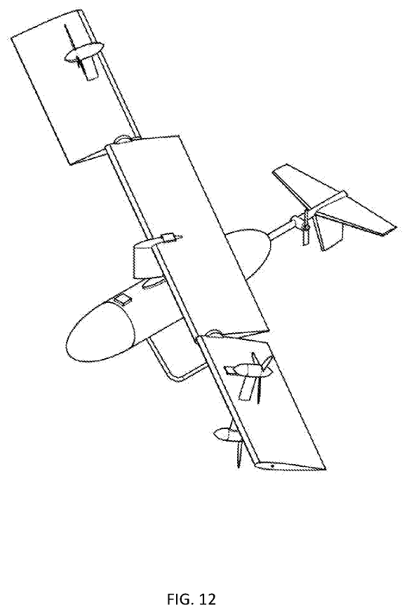

With reference to FIG. 12, where the hub is axially connected to an airframe, it may also be designed to pivot around a longitudinal and/or later axis. This would provide a connection to an airframe that would resemble a conventional teetering rotor head. Alternatively, the pivotal connection between the one or more wings and the hub may be designed to have an amount of flexibility, resulting in a connection similar in function to a conventional flapping rotor hinge.

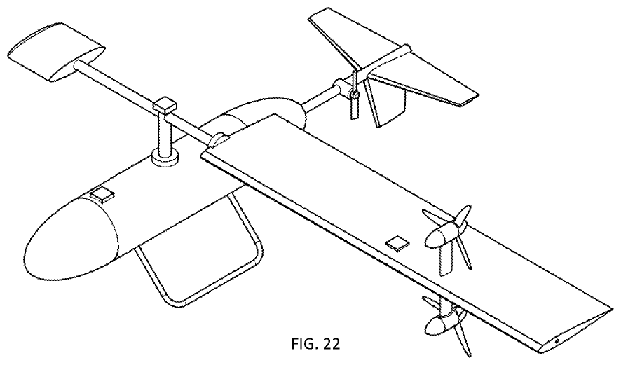

In an embodiment, the pivoting wing, thruster and hub system may utilize only one wing, which may be seen in FIGS. 17 and 18. In this embodiment, the pivoting wing, thruster and hub system would function as a single rotor helicopter and be incapable of horizontal flight. In this embodiment, a pivotal connection between the one wing and the hub may not be needed, but would require the hub to pivot along the wing pivot axis as the wing does when the wing changes pitch. To counterbalance the weight of the wing, a counterweight may be positioned opposite the wing 15, wherein the counterweight may be composed of heavy but necessary components such as batteries, electronics or thrusters. Where the thrusters 20, 24 form the counterweight, the thruster provides rotational force to the wing. FIG. 21 is a perspective view of an embodiment of the pivotally-connected wing with a fuselage beside the wing, and FIG. 22 is a perspective view of an embodiment of the pivotally-connected wing having a single rotor wing.

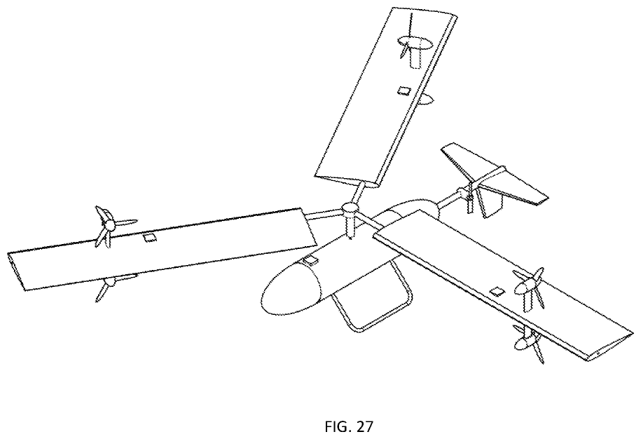

In an embodiment, may utilize more than two wings. In reference to FIG. 27, the pivoting wing, thruster, and hub system comprises of three wing assemblies and functions much like a multi-blade helicopter. In the embodiment, the hub is provided as a rotary component, mounted on top of a fuselage, with multiple extensions connecting to the wing assemblies. Wherein, each wing assembly is further comprised of one thruster mounted on the top of the wing and one thruster mounted below the wing. Each wing assembly may further comprise of one or more IMUs, and be able to rotate about the extension of the hub.

Although the invention has been explained in relation to its preferred embodiment, it is to be understood that many other possible modifications and variations can be made without departing from the spirit and scope of the invention as herein described.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A pivoting wing system comprising:
a. a hub; and
b. one or more wing assemblies extending from the hub, each wing assembly comprising:
i. a wing having a top and bottom, wherein the wing defines a spanwise axis;
ii. one or more thrust producing devices mounted to the top of the wing; and
iii. one or more thrust producing devices mounted to the bottom of the wing,
wherein the one or more top-mounted thrust producing devices and the one or more bottom-mounted thrust producing devices pivot the wing assemblies about the spanwise axis.

2. The pivoting wing system of claim 1, wherein the hub comprises an airfoil segment.

3. The pivoting wing system of claim 1, further comprising a power source in communication with the one or more top-mounted thrust producing devices and the one or more bottom-mounted thrust producing devices.

4. The pivoting wing system of claim 3, wherein the power source is a battery.

5. The pivoting wing system of claim 1, wherein the wing assemblies are rotatably mounted to the hub.

6. The pivoting wing system of claim 1, wherein the wing assemblies are flexibly mounted to the hub.

7. The pivoting wing system of claim 1, further comprising one or more positioning sensors.

8. The pivoting wing system of claim 1, further comprising a fuselage axially connected to the hub.

9. The pivoting wing system of claim 8, wherein the fuselage comprises a landing component.

10. The pivoting wing system of claim 8, wherein the fuselage comprises one or more stabilizing elements.

11. The pivoting wing system of claim 10, wherein the one or more stabilizing elements are one or more thrust producing devices.

12. The pivoting wing system of claim 1, further comprising a landing component.

13. The pivoting wing system of claim 12, wherein the landing component is a plurality of rounded surfaces.

14. The pivoting wing system of claim 1, wherein the wing assemblies are rigidly attached to the hub.

15. A pivoting wing system comprising:
a. a hub having a first and second end;
b. a wing defining a spanwise axis, wherein the wing extends from the first end of the hub; and
c. one or more thrust producing devices disposed on the second end of the hub above the spanwise axis;
d. one or more thrust producing devices disposed on the second end of the hub below the spanwise axis,
wherein the one or more top-mounted thrust producing devices and the one or more bottom-mounted thrust producing devices pivot the wing about the spanwise axis, and wherein the one or more top-mounted thrust producing devices and the one or more bottom-mounted thrust producing devices rotate the wing about an axis generally perpendicular to the spanwise axis.

16. The pivoting wing system of claim 15, further comprising a power source in communication with each of the one or more top-mounted thrust producing devices and the one or more bottom-mounted thrust producing devices.

17. The pivoting wing system of claim 15, further comprising a fuselage axially connected to the hub.

18. The pivoting wing system of claim 17, wherein the fuselage further comprises one or more stabilizing elements.

19. The pivoting wing system of claim 18, wherein the one or more stabilizing elements are the one or more top-mounted thrust producing devices and the one or more bottom-mounted thrust producing devices.

20. The pivoting wing system of claim 15, further comprising one or more positioning sensors.
